(19) United States
(12) Patent Application Publication
(10) Pub. No.: US 2005/0182707 A1
(43) Pub. Date: Aug. 18, 2005

(54) Online auction referral and compensation system

(76) Inventor: Wayne Bell Yeager, Lexington, KY (US)

Correspondence Address: Wayne Yeager, 3777 Dicksonia Drive, Lexington, KY, 40517, US

(21) Appl. No.: 10/946,858

(22) Filed: Sep. 21, 2004

Related U.S. Application Data
(60) Provisional application No. 60/504,933, filed on Sep. 23, 2003.

(51) Int. Cl. G06F 17/60

(52) U.S. Cl. 705/37

(57) ABSTRACT

A system for promoting an online auction whereby an affiliate promotes said auction on behalf of the seller in exchange for an agreed-upon commission or fee paid to said affiliate by said seller upon the successful sale of the item to a buyer referred to said auction by said affiliate. The system is implemented in part by a specially formulated referral link which contains data regarding the affiliate partner, in part by computer code that is embedded on the seller's auction page(s), and in part by affiliate referral software that runs on a separate webserver.

This application claims the benefit of U.S. Provisional Application No. 60/504,933, filed Sep. 23, 2003.

### FIELD OF THE INVENTION

This invention relates to electronic commerce. Specifically, this invention relates to a method of marketing and selling goods via online auctions. More specifically, this invention relates to a method of marketing and selling goods via online auctions by paying web site owners a commission for referring visitors to said online auctions.

### BACKGROUND OF THE INVENTION

Online auction destinations on the World Wide Web (such as eBay, Yahoo and Amazon) are becoming increasingly popular for both buyers and sellers, and now represent a substantial portion of all electronic commerce.

The main “bottleneck” to success for online auction sellers is getting potential buyers to the sellers' auction pages.

One way of attracting potential buyers to one's auction is to write the description of the item for sale in such a way that it will likely be found by potential buyers searching for related keywords in the auction venue's search box. This poses several problems, however, not the least of which is the difficulty of trying to guess the manner in which potential buyers might be searching for an item. Furthermore, using such a method, one cannot adequately reach customers who may have a need for the item, but who are unaware that such an item is available, and who, consequently, would likely not perform a search for the item.

Another way of attracting potential buyers is to promote the online auction in a medium other than the auction venue itself. This medium is typically one or a combination of the following: email, popups, popunders, DHTML layering, online newsletters, websites, RSS feeds, IRC chat, or some other online method that allows interested parties to click a hyperlink that transfers them to the appropriate auction page. The main problem with this method is that advertising an auction in such a way can be expensive, and can consume significant human resources. In addition, it is often difficult or impossible to evaluate the effectiveness of a given advertisement. Furthermore, methods such as email, popups, popunders, DHTML layers, IRC chat, et al, are becoming unpopular with the internet community due to their interruptive nature and may create a negative impression on the online auction seller using such methods.

The present invention addresses these and other problems.

### SUMMARY OF THE INVENTION

The present invention provides a software system and method for enabling an online auction seller, referred to herein as the “seller,” to efficiently market and sell goods in an online auction environment in cooperation with other business partners, referred to herein as “affiliates.” The system and method are implemented in part by a specially formulated referral link which contains data regarding the affiliate partner, in part by computer code that is embedded on the seller's auction page(s), and in part by software that runs on a separate webserver.

Through the software that runs on the separate webserver, a seller can describe items the seller is or will be auctioning on an online auction site, and the commission or fee the seller will pay for affiliates who refer the winning bidder to the auction(s).

Through the software that runs on the separate webserver, an entity can enroll (via an automated registration process) as an affiliate. The affiliate can then, on his or her own website, or other means available to the affiliate, disseminate information about a specific auction (or auctions) that may include the affiliate's review and/or recommendations on the specific item being auctioned by the seller. The affiliate can provides a hyperlink to the auction, in which is embedded affiliate tracking data for the purposes of indicating the referring affiliate.

In accordance with one aspect of the invention, auction-specific hyperlinks, referred to herein as “referral links,” are generated for affiliates by the affiliate tracking software. These hyperlinks, or links, allow potential buyers to visit a seller's auction page to bid on (or purchase) the item (or items) being offered for sale. Each referral link contains referral information that is transmitted to the tracking software on the separate webserver by a script embedded in each auction page. Information related to the potential customer is recorded on the webserver when the potential customer clicks on the referral link. This referral information preferably includes the unique ID of the affiliate (assigned upon enrollment) and the unique ID of the auction. Referral processing software running on the webserver uses this information to identify the affiliate that referred the potential customer to the auction page. If the customer subsequently purchases the item being auctioned, the referral processing software on the webserver credits the referring affiliate for the sale by, for example, applying a commission or agreed-upon flat fee to the affiliate's account.

In one implementation, the referral commission is automatically deducted from the seller's prepaid account. Another implementation includes deducting the commission due from the seller's bank account, with prior agreement. Another implementation would allow the seller and affiliate to agree to the manner in which payment will be made to affiliate upon the successful sale of seller's item(s).

Prior art referral programs, including U.S. Pat. No. 6,029,141 “Internet-based customer referral system”, and all other programs known in the art, are designed for online merchants that own, maintain or control their own websites. These referral programs do not address, and cannot be used by, online auction sellers, due to the fact that online auction sellers are promoting a web page (or web pages) being hosted by a third party (the auction venue), and therefore do not have access to sufficient user data to properly maintain a referral-based commission program.

Prior art software-based referral programs involve the installation of software on a webserver owned, rented, leased or controlled by the seller. Auction venues generally do not give their sellers the opportunity to load software onto the auction venue's webservers. That policy renders prior art referral programs, and the software that supports them, useless.

Prior art online or Application Service Provider (ASP) referral programs may not require the installation of software, but they require that the transaction be consummated, and payment tendered, at the provider's website. Again, these ASP referral programs are unable to provide sellers with sufficient user data to properly maintain a referral-based commission program on a third-party site.

Finally, while referral programs in the online auction environment are known in the art, they have previously been used merely to refer potential buyers to the auction venue itself, and have not paid affiliates any com-missions based on the final price of a specific item or items. Furthermore, since these programs are managed by the auction venues themselves, the auction sellers have no control of the payout amounts or other incentives offered to affiliates by the auction venues, and thus cannot use prior art programs to directly encourage potential buyers to visit said sellers' auctions.

The system and method disclosed in the present invention provides a unique and novel solution to these dilemmas for those who sell goods and services through third-party auction venues.

The primary object of the present invention is to allow online auction sellers the opportunity to attract more potential buyers to their auctions by marketing said auctions through a commission-based referral program, and to allow website owners the opportunity to earn commissions by promoting specific online auctions.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a drawing illustrating the primary components of a system that operates in accordance with the present invention.

FIG. 2 is a flow diagram illustrating a typical referral sequence in accordance with the present invention.

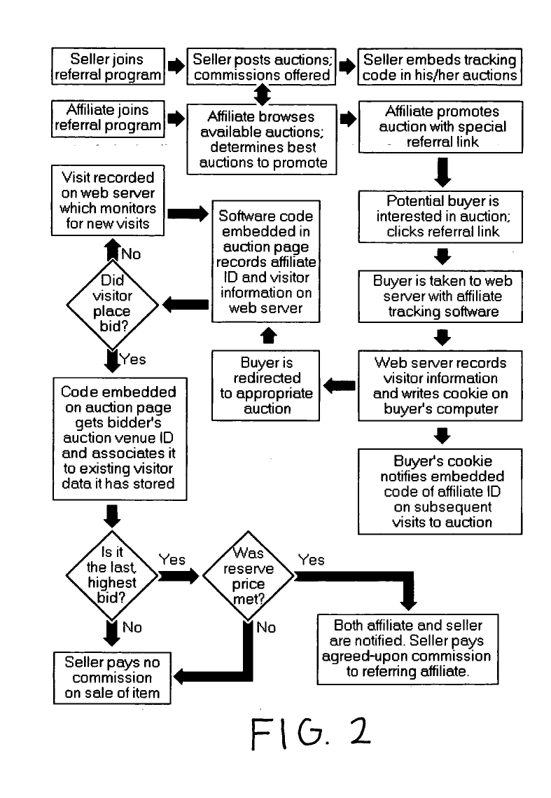

### DETAILED DESCRIPTION OF THE INVENTION

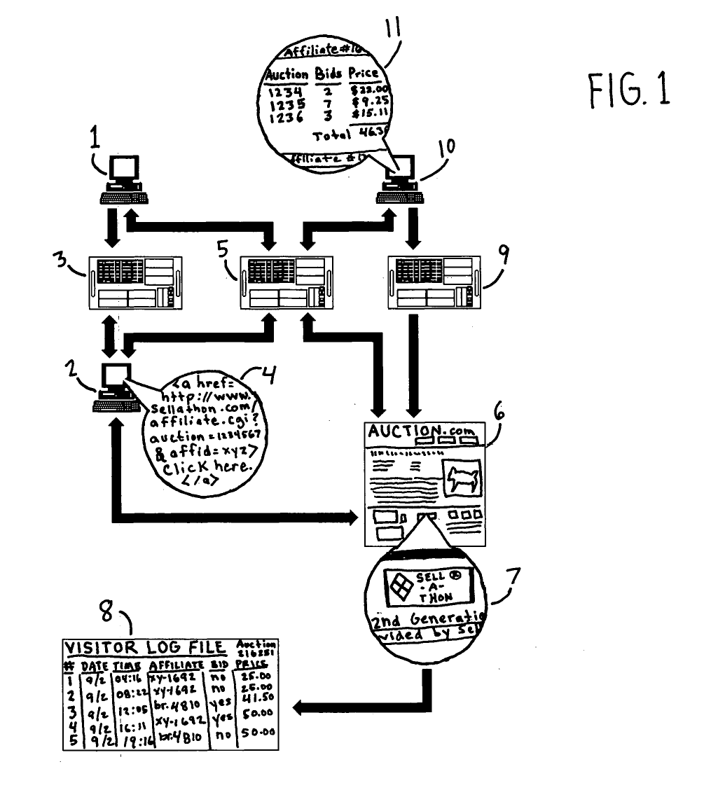

FIG. 1 illustrates the general architecture of a referral system that operates in accordance with the present invention. The system includes an affiliate 1, an affiliate's website hosted on server 3, a potential buyer 2, a seller 10, and a webserver 5 that contains affiliate tracking software, all of which are linked together by the Internet.

The affiliate processing software that exists on webserver 5 implements an automated affiliate enrollment process for allowing individuals and business entities to register as affiliates. The enrollment process is implemented in part by web pages that are transmitted to the computer of the affiliate applicant, and by enrollment software that runs on the webserver. During the enrollment process, the applicant is presented with an online business agreement (in the form of a web page, hereinafter called the “Terms of Service”) that sets forth the terms and conditions of doing business with the provider of this service. In addition, the applicant is presented with an online form that requests various information, such as the name, payment address and email address of the applicant and a description of the potential affiliate's website.

The affiliate processing software also implements an automated process for allowing an auction seller 10 to indicate which auctions he would agree to pay commissions for, and the amount of commissions he would agree to pay. The enrollment process for sellers is implemented in part by web pages that are transmitted to the computer of the seller, and by enrollment software that runs on the webserver 5. During the enrollment process, the seller is presented with “Terms of Service” by which the seller agrees to abide. In addition, the seller

is presented with an online form that requests various information, such as the name, street address, email address and banking details of the seller. The latter is provided for the facilitation of payment to affiliates who refer successful high bidders to the seller's auction(s).

The auction seller is also provided with a code that is added to his auction description. This code aids in the affiliate tracking process by reading the data contained within each visitor's browser's environment variable known as the “referring document” (the last web page a visitor viewed before viewing the current web page) and transmitting that data to webserver 5.

An example of such a code demonstrates how this is accomplished. (The following example is in JavaScript, but any scripting language will suffice.)

<script language=“javascript”>
document.write(“<img
src=http://www.xyz.com/cgi-bin/track.cgi?referrer=”
+ escape(document.referrer) + “>”);
</script>

When placed inside a webpage, this will transmit to the CGI script identified in this example as track.cgi, the value contained within the referring document environment variable, and assign that value to the variable name “referrer”.

The CGI script, or any dynamic script that can read incoming queries using the GET method, resides on webserver 5, and uses this referrer data to identify the URL the visitor was viewing just prior to arriving at the auction page.

At this point, the auction is ready to accept affiliates to promote the auction.

Affiliates scan a list of auction sellers offering commissions, the item(s) being auctioned by the seller, and the amount of commission each seller is willing to pay. In this marketplace environment, affiliates can decide where the most profitable use of their time and efforts lay.

If an affiliate determines that promoting a particular auction may be profitable, and the affiliate indicates his interest in promoting the auction, a specially formatted link is generated by the software on webserver 5, and provided to the affiliate.

For illustrative purposes, such a link might be created thusly:

<a href=“http://www.sellathon.com/cgi-bin/
affiliate.cgi?auction=1234567&affid=xyz”>

Contained within this hyperlink are two data points: the affiliate's unique ID and the unique ID number of the auction being promoted.

An affiliate who wishes to promote a particular auction can place this link on a website being hosted by server 3, along with, if he chooses, additional information on, or even a recommendation for, the item being sold.

Alternately, an affiliate may choose not to promote a particular auction, but instead provide specific parameters regarding the type of item or items said affiliate wishes to promote, such as “items with elephant in the title” or “items with start prices over $10,000 in Category #550.” The affiliate tracking software on webserver 5 can then automatically generate appropriate items for said affiliate to promote based on said affiliate's pre-selected criteria.

A visitor 2 to the affiliate's website may choose to click the referral link 4 that appears on the affiliate's website, and visit the auction 6 being promote. When the visitor 2 clicks the referral link, he is first directed to webserver 5. The software on webserver 5 reads and logs data related to this visit, including the auction ID contained within the referral link 4, the affiliate ID contained in the same, as well as the visitor's IP address, the date and time of the visit, and any other identification information that may available.

In the preferred embodiment, the software also embeds a persistent cookie on the visitor's computer to further aid in tracking said visitor's auction bidding activity.

Once the software has logged the aforementioned data, the visitor is redirected to the appropriate auction page 6. The appropriate auction is identified in the referral link, using the “auction=” variable.

Auction page 6 is loaded from a webserver 9 operated by the auction venue. When the webserver 9 sends the HTML code (the markup code that causes the auction page 6 to render inside a visitor's web browser) to the visitor 2, it also sends the referral-grabbing tracking code (a JavaScript example of which was provided earlier) embedded by the seller.

In the preferred embodiment of the present invention, when the tracking code is rendered inside the visitor's browser, it places an image file 7 (remotely loaded from webserver 5) at the bottom of the auction page. Contained within the request for the image file 7 is the transmission to webserver 5 of the contents of the variable “referrer”. (See sample JavaScript code above.)

By requesting the “image” called...
“http://www.xyz.com/cgi-bin/track.cgi?referrer=”

. . . (followed by the actual referring document), the script called track.cgi is able to execute on webserver 5 and act on the referral data provided by the “referrer=” variable.

With knowledge of the referring data contained within the variable “referrer”, the affiliate tracking software that resides on webserver 5 can positively assign credit for this visit to the affiliate “xyz” (since the referring document will be, for example,

http://www.sellathon.com/cgi-bin/
affiliate.cgi?auction=1234567&affid=xyz.

The software, therefore, logs the visit with proper assignment of credit into a permanent visitor record 8 for a specific auction 6.

This permanent visitor record 8 is made available, in raw form or customized form, to both the seller and the affiliate in the form of a real-time report 11, containing one or more pieces of the following information: the auction number, the IP address of the visitor, whether the visitor placed a bid, if so, the amount of the bid, the unique ID number of the seller and the unique ID number of the affiliate. More data may be included in the report if desired.

On subsequent visits to the auction 6, the visitor 2 will most likely not click the affiliates referral link, but will instead go directly to the auction page. In that instance, the persistent cookie that was written to the visitor's computer on the initial visit will be read on each subsequent visit to positively identify the visitor and the affiliate who initially referred the visitor to the auction.

That process is performed automatically each time the auction is loaded. When the auction 6 is loaded, the image 7 is also loaded. Since the image tag loads not only an image, but also loads a remotely-executed CGI script that exists on webserver 5, the CGI script can read the HTTP_COOKIE environment variable (if it exists) each time and log the data contained within that cookie in the appropriate logfile.

At the end of the auction, the tracking software that exists on webserver 5 will determine if the final and/or highest bid was placed by a visitor referred by the affiliate 1.

This determination can be made in a variety of ways, but in the preferred embodiment, the embedded code placed on the auction page 6 will retrieve portions of the HTML seen by the visitor 2, and if the said HTML portions match the characteristics of an auction page in which a bid has just been placed, that visitor's auction venue ID is associated with the currently stored data about said visitor and associated with the existing data contained in the visitor's persistent cookie.

During the initial visit, a visitor to an auction page referred by an affiliate has a persistent cookie written to his computer. Therefore, by analyzing the referral data contained within the contents of the HTTP_COOKIE environment variable, the tracking software can associate bids (and bidder IDs) with the appropriate referring affiliate.

If, at the end of the auction, the high bidder is associated with a referring affiliate, that association is noted and credit for the sale given to the referring affiliate.

In another embodiment, the tracking software can download the auction page after each bid is placed, and by parsing the contents of that page, obtain the unique user name assigned to that bidder by the auction venue. By reading the HTTP_COOKIE environment variable, the tracking software can positively associate that user name to the affiliate who referred him. At the end of the auction, the auction page can once again be parsed to determine the unique user name of the successful bidder. By comparing that to the records of all tracked bids, the referring affiliate (if any) of the successful bidder can be identified.

Whichever method is used to associate a bid with its attendant affiliate data, both the affiliate 1 and the seller 10 will be notified that the successful high bid was made by a visitor referred by the affiliate, and that a commissions is due the affiliate.

While the preferred embodiment is to allow the online auction seller 10 to reward the affiliate 1 for sending the high bidder to the seller's auctions, it will be apparent to those skilled in the art that this invention also allows the online auction seller 10 to pay the affiliate 1 for any activity that may be undertaken by the auction visitor 2 and that can be tracked by the tracking software on webserver 5, including paying the affiliate 1 a flat fee for merely sending the visitor to the seller's auction, paying the affiliate 1 a flat fee for sending the visitor 2 to the auction, but only if the visitor 2 stays on the auction for a certain length of time, or, paying the affiliate a flat fee if and when the visitor places a bid (but not necessarily the final high bid).

In the preferred embodiment, both the affiliate and the seller have an account with the provider of this service. The seller makes a deposit into his account representing approximately the agreed-upon commission if the item is sold to an affiliate-referred visitor. When a commission is due the affiliate, the provider can transfer the appropriate amount of funds from the seller's account to the affiliate's.

In another embodiment, the seller can keep his banking details on file with the provider of this service. When a commission is due the affiliate, the provider can present a demand draft (or any form of money transfer) to the seller's bank for payment. Once received, the provider of this service transfers these funds to the affiliate's account.

In another embodiment, the seller and affiliate can simply agree on the method and the timing of the commission payment.

Upon the completion of a transaction, the buyer and/or seller will have access to a feedback mechanism for the purpose of rating their experience. By leaving public feedback on the transaction as a whole, and by rating the other party specifically, potential, future affiliates and sellers will be able to more accurately determine the desirability of partnering with another party, based on earlier ratings.

While the invention has been described herein with reference to certain preferred embodiments, these embodiments have been presented by way of example only, and not to limit the scope of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system whereby an online auction seller rewards affiliates for promoting said seller's online auctions, comprising:
an online auction seller determining which auction to promote via affiliates;
said online auction seller determining the commission rate or flat fee to be paid to affiliates for referring visitors;
said affiliate referring visitors to said online auction;
said visitor visiting said online auction;
visitor tracking software that records the online auction activity of said visitor; and
said online auction seller rewarding said affiliate for referring said visitor.

2. A system whereby online auction sellers reward affiliates to promote said sellers' online auctions, comprising:
an online auction seller obtaining a visitor tracking code;
said online auction seller emplacing said visitor tracking code into an online auction description;
said online auction seller determining which auction or auctions to promote via affiliates;
said online auction seller determining the commission rate or flat fee to be paid to affiliates for referring the high bidder to said auction(s);
an affiliate obtaining an affiliate ID;
said affiliate obtaining an auction ID for an auction said affiliate desires to promote;
affiliate promoting a Uniform Resource Locator (URL) containing said affiliate ID and said auction ID;
a visitor referred by said affiliate opening said URL in a web browser;
affiliate referral software that records said visitor's activity data and redirects said visitor to said auction;
said visitor tracking code that communicates with external web server regarding said visitor's auction activity;
said visitor placing high bid on said auction;
said visitor being high bidder at the end of said auction;
said affiliate referral software notifying said seller and said affiliate that said visitor was said high bidder; and
said affiliate referral software transferring agreed-upon funds from said seller's account to said affiliate's account as a commission or flat fee for referring said high bidder to said auction.

3. A system whereby online auction sellers reward affiliates to promote said sellers' online auctions, comprising:
an online auction seller obtaining a visitor tracking code;
said online auction seller emplacing said visitor tracking code into an online auction description;
said online auction seller determining which auction or auctions to promote via affiliates;
said online auction seller determining the commission rate or flat fee to be paid to affiliates for referring the high bidder;
an affiliate obtaining an affiliate ID;
said affiliate obtaining an auction ID for an auction said affiliate desires to promote;
said affiliate promoting a Uniform Resource Locator (URL) containing said affiliate ID and said auction ID;
a visitor referred by said affiliate opening said URL in a web browser;
affiliate referral software that records said visitor's activity data and redirects said visitor to said auction;
said visitor tracking code that communicates with external web server regarding said visitor's auction activity;
said visitor placing high bid on said auction;
said visitor being high bidder at the end of said auction;
said affiliate referral software notifying said seller and said affiliate that said visitor was said high bidder; and
said affiliate referral software prompting said seller to pay said affiliate agreed-upon commission or flat fee for referring said high bidder to said auction.

4. The system of claim 1, wherein said commission rate and said flat-fee is determined by the organization hosting said system.

5. The system of claim 2, wherein said commission rate and said flat-fee is determined by the organization hosting said system.

6. The system of claim 3, wherein said commission rate and said flat-fee is determined by the organization hosting said system.

7. The system of claim 1, wherein said URL is visited by said visitor using an appliance or device other than a web browser.

8. The system of claim 2, wherein said URL is visited by said visitor using an appliance or device other than a web browser.

9. The system of claim 3, wherein said URL is visited by said visitor using an appliance or device other than a web browser.

10. The system of claim 1, wherein said affiliate provides parameters regarding the type of auction(s) to promote, and said auctions to promote are automatically determined for said affiliate by said affiliate referral software.

11. The system of claim 2, wherein said affiliate provides parameters regarding the type of auction(s) to promote, and said auctions to promote are automatically determined for said affiliate by said affiliate referral software.

12. The system of claim 3, wherein said affiliate provides parameters regarding the type of auction(s) to promote, and said auctions to promote are automatically determined for said affiliate by said affiliate referral software.

13. A system whereby online auction sellers reward affiliates to promote said sellers' online auctions, comprising:
an online auction seller obtaining a visitor tracking code; auction
said online auction seller emplacing said visitor tracking code into an online description;
said online auction seller determining which auction or auctions to promote via affiliates;
said online auction seller determining the commission rate or flat fee to be paid to affiliates for referring a visitor to said auction;
an affiliate obtaining an affiliate ID;
said affiliate obtaining an auction ID for an auction said affiliate desires to promote;
said affiliate promoting a Uniform Resource Locator (URL) containing said affiliate ID and said auction ID;
a visitor referred by said affiliate opening said URL in a web browser;
affiliate referral software that records said visitor's activity data and redirects said visitor to said auction;
said visitor tracking code that communicates with external web server regarding said visitor's auction activity;
said visitor visiting said auction;
said affiliate referral software notifying said seller and said affiliate that said visitor visited said auction; and
said affiliate referral software prompting said seller to pay said affiliate agreed-upon commission or flat fee for referring said visitor to said auction.

14. The system of claim 13, wherein said commission rate and said flat-fee is determined by the organization hosting said system.

15. The system of claim 13, wherein said URL is visited by said visitor using an appliance or device other than a web browser.

16. The system of claim 13, wherein said affiliate provides parameters regarding the type of auction(s) to promote, and said auctions to promote are automatically determined for said affiliate by said affiliate referral software.

17. The system of claim 1, wherein said affiliate and said seller are given the opportunity to provide feedback regarding the other's performance in the transaction.

18. The system of claim 2, wherein said affiliate and said seller are given the opportunity to provide feedback regarding the other's performance in the transaction.

19. The system of claim 3, wherein said affiliate and said seller are given the opportunity to provide feedback regarding the other's performance in the transaction.

20. The system of claim 13, wherein said affiliate and said seller are given the opportunity to provide feedback regarding the other's performance in the transaction.
